(19) United States
(12) Patent Application Publication
(10) Pub. No.: US 2023/0203244 A1
(43) Pub. Date: Jun. 29, 2023

(54) A METHOD FOR IMPROVING L* COLOR IN A PET POLYMER

(71) Applicant: Koch Technology Solutions, LLC, Wichita, KS (US)

(72) Inventor: Clive Alexander HAMILTON, North Yorkshire (GB)

(73) Assignee: Koch Technology Solutions, LLC, Wichita, KS (US)

(21) Appl. No.: 17/927,361

(22) PCT Filed: Jun. 2, 2021
(86) PCT No.: PCT/IB2021/054840

§ 371 Date: Nov. 23, 2022

Related U.S. Application Data
(60) Provisional application No. 63/035,177, filed on Jun. 5, 2020.

(51) Int. Cl. C08G 63/40; C08G 63/80; C08G 63/86; C08G 63/83; C08G 63/84; C08G 63/183

(52) U.S. Cl. CPC C08G 63/40; C08G 63/80; C08G 63/83; C08G 63/84; C08G 63/183; C08G 63/866

(57) ABSTRACT

A method for improving L* color of polyethylene terephthalate polymer, the method including bis-hydroxylethyl-eneterephthalate being polycondensed to produce said polyethylene terephthalate polymer in a polyethylene terephthalate manufacturing process, and wherein said process requires an antimony-containing catalyst, the method comprising the steps of: i) adding said antimony-containing catalyst at a temperature in a range of a melting point of said BHET to an upper temperature of 220° C.; and ii) exposing said BHET in a molten state to glycol removal before addition of said antimony-containing catalyst.

### CROSS-REFERENCE TO RELATED APPLICATIONS

This application claims the benefit of U.S. Provisional Application No. 63/035,177, filed Jun. 5, 2020, the disclosure of which is incorporated herein by reference in its entirety.

### FIELD

The present disclosure relates to a method for improving L* color of a polyethylene terephthalate (PET) polymer in a PET manufacturing process, a polyethylene terephthalate polymer produced by said method, and a shaped product produced by the polyethylene terephthalate polymer.

### BACKGROUND

Polyethylene terephthalate (PET) is a synthetic material that was first made in the mid-1940s. PET has desirable properties and processing abilities and hence is now used extensively on a global scale for packaging applications in the food and beverage industries and for industrial products, as well as in the textile industry.

Typically, PET has petrochemical origins. Purified terephthalic acid is first formed via aerobic catalytic oxidation of p-xylene in acetic acid medium in a purified terephthalic acid manufacturing facility. This purified terephthalic acid (PTA) is subsequently reacted with ethylene glycol to produce a PTA-based oligomer (and water), which polycondenses to form PET polymer. An alternative route to PET polymer is via polymerisation of a bis-hydroxylethyleneterephthalate (BHET) monomer, although this route is less favorable from a process economic point of view. The BHET monomer is formed through the reaction of dimethylterephthalate (DMT) (a diester formed from terephthalic acid and methanol) with ethylene glycol, and then the BHET monomer polymerises with itself to form longer chains of PET.

In a typical PET manufacturing process, there are three main stages in the melt-phase process to make the PET polymer: (1) esterification, (2) pre-polymerisation, and (3) polymerisation. When making PET resin, the PET polymer enters a further solid-state polymerisation (SSP) stage to make changes, which include increasing the molecular weight of the polymer. In the initial esterification stage, the PTA (or DMT) and ethylene glycol are mixed and fed into an esterification unit, where esterification, which may be catalysed or uncatalyzed, takes place under atmospheric pressure and a temperature in the range of 270° C. to 295° C. Water (or methanol in the case of DMT) resulting from the esterification reaction and excess ethylene glycol are vaporised. Additives, including catalysts, toners etc., are typically added to the process in between the esterification stage and the subsequent pre-polymerisation stage. In the pre-polymerisation stage, the product from the esterification unit is sent to a pre-polymerisation unit and reacted with extra ethylene glycol at a temperature in the range of 270° C. to 295° C. under significantly reduced pressure to allow the degree of polymerisation of the oligomer to increase. During the polymerisation stage, the product from the pre-polymerisation stage is again subjected to low pressures and a temperature in the range of 270° C. to 295° C. in a horizontal polymerisation unit, typically known as the Finisher, to further allow an increase in the degree of polymerisation to approximately 80-120 repeat units. When making PET resin, a fourth, solid-state polymerisation (SSP) stage is usually required involving a crystallisation step wherein the amorphous pellets produced in the melt phase process are converted to crystalline pellets, which are then subsequently processed further depending on the final PET product, which may be as diverse as containers/bottles for liquids and foods, or industrial products and resins.

It is desirable to recycle post-consumer PET-containing waste material to reduce the amount of plastic sent to landfill. One known recycling method is to take post-consumer PET-containing waste material, such as PET plastic bottles, and mechanically break it up to produce post-consumer recycled (PCR) flake. This PCR flake may be glycolyzed to convert it to recycled bis-hydroxylethyleneterephthalate (rBHET). This rBHET can then be used in a PET manufacturing process to make recycled PET (rPET; so-called because the oligomer upon which it is based is derived from post-consumer PET or PCR, rather than PTA or DMT). This circumvents the need to use more PTA with petrochemical origins, in combination with ethylene glycol, to make a PTA-based oligomer in a virgin PTA (vPTA) process or to make virgin BHET (vBHET) in a virgin DMT (vDMT) process. In addition, since lower amounts of petrochemicals are required to make recycled PET (rPET) as compared to new PET, known as virgin PET (vPET), rPET consequently has a lower carbon footprint than vPET. Therefore, rPET is attractive based on its ‘green’ credentials, which themselves may confer economic benefits in certain jurisdictions.

However, rPET made from rBHET tends to have lower reactivity in the melt phase process and in the solid phase polymerisation stage. If rBHET is used in a PET manufacturing process, the amount of rPET manufactured is approximately 20% lower than if a vPTA-based oligomer is used, i.e. oligomer made through esterification of purified terephthalic acid with ethylene glycol.

Further still, rPET made from rBHET tends to be darker (lower L*) and more yellow, which is mainly due to impurities present in the rPET polymer. In addition, when a BHET monomer formed through the reaction of dimethylterephthalate (DMT) with ethylene glycol is used to form PET, the DMT-based resin produced by the melt phase process is darker, with an L* of typically about 62. This is a common observation, regardless of whether the BHET monomer is formed by reacting DMT with ethylene glycol or produced by glycolyzing PET or PET-containing waste. In contrast, the amorphous resin from a standard process based on a PTA-based oligomer used for making vPET would be brighter and typically have an L* color value of about 65. At present, therefore, rPET manufacturing processes using rBHET (glycolysis product of PET-containing waste) are neither attractive nor competitive when compared with processes using PTA-based oligomer.

Therefore, there exists a need for a method for producing a PET polymer from BHET which has a higher L* color and consequently an increased level of brightness.

### SUMMARY OF INVENTION

The present disclosure provides, inter alia, a method for improving (i.e., increasing) L* color of polyethylene terephthalate polymer, the method comprising polycondensing bis-hydroxylethyleneterephthalate (BHET) to produce the polyethylene terephthalate polymer in a polyethylene terephthalate manufacturing process, and wherein said process requires an antimony-containing catalyst, the method comprising the steps of: (i) adding said antimony-containing catalyst at a temperature in a range of a melting point of said BHET to an upper temperature of 220° C.; and/or ii) exposing said BHET in a molten state to glycol removal to below 10% free (unreacted) glycol and preferably below 5% free glycol prior to the addition of said antimony-containing catalyst.

In some embodiments, the antimony-containing catalyst is added at a temperature between 150° C. to 200° C., preferably from 170° C. to 190° C., more preferably between 185° C. to 195° C. In some embodiments, the BHET in the molten state is exposed to glycol removal at a temperature range of 150° C. to 200° C., preferably from 170° C. to 190° C., more preferably between 185° C. to 195° C. In some embodiments, the exposure to glycol removal occurs at a pressure range of 100 mmHg to 760 mmHg, preferably 120 mmHg to 170 mmHg.

In some embodiments, the BHET is derived from either post-consumer PET-containing waste material or from a dimethyl terephthalate process. In some embodiments, the dimethyl terephthalate is v-dimethyl terephthalate or r-dimethyl terephthalate. In some embodiments, the post-consumer PET-containing waste material is a post-consumer recycled (PCR) flake.

In some embodiments, the antimony-containing catalyst is antimony trioxide, antimony glycolate or antimony triacetate.

The present disclosure also provides a method for improving L* of polyethylene terephthalate polymer by adding a non-antimony-containing catalyst, wherein bis-hydroxylethyleneterephthalate is polycondensed to produce said polyethylene terephthalate polymer in a polyethylene terephthalate manufacturing process. In some embodiments, the non-antimony-containing catalyst includes any one of titanium, zinc, aluminium, germanium or manganese. In some embodiments, the non-antimony-containing catalyst is a titanium alkoxide, titanium isopropoxide or titanium n-butoxide. In some embodiments, the non-antimony-containing catalyst contains any one of zinc acetate, manganese acetate, an alkyltin compound or an aluminium alkoxide.

The present disclosure also provides a polyethylene terephthalate polymer produced by a process described herein. The present disclosure also provides a shaped product produced by a polyethylene terephthalate polymer that is produced by a process described herein.

### BRIEF DESCRIPTION OF THE FIGURES

FIG. 1 is a schematic diagram of a process for producing PET in accordance with one embodiment of the present disclosure.

FIG. 2 is a schematic diagram of a process for producing PET in accordance with a further embodiment of the present disclosure.

### DETAILED DESCRIPTION

Disclosed herein are methods for improving L* color of PET in a PET manufacturing process, a polyethylene terephthalate polymer produced by the disclosed methods and a shaped product produced by the polyethylene terephthalate polymer as disclosed herein.

The methods disclosed herein address a problem recognized in the art with respect to the darker and yellower color of PET prepared from rBHET as compared to PET prepared from vBHET. In particular, the disclosure provides a means to improve (i.e., increase) the L* color of rPET produced from rBHET, thereby increasing the utility of recycled starting materials in the manufacture of PET polymers and products.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. In case of conflict, the present specification, including definitions, will control.

In addition, the materials, methods, and examples are illustrative only and not intended to be limiting. The details of one or more embodiments of the invention are set forth in the accompanying drawings and the description below. Other features, objects, and advantages of the invention will be apparent from the description and the drawings, and from the claims. The word “comprising” in the claims may be replaced with “consisting essentially of” or with “consisting of,” according to standard practice in patent law.

Unless specifically stated otherwise or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The term “PET” refers to polyethylene terephthalate.

The term “PTA” refers to purified terephthalic acid.

The term “vPTA” refers to PTA synthesised via aerobic catalytic oxidation of p-xylene in acetic acid medium.

As used herein, “PTA-based oligomer” refers to a short-chain PET oligomer synthesised through a process requiring esterification of purified terephthalic acid with ethylene glycol. Purified terephthalic acid (PTA) is reacted with ethylene glycol to produce the PTA-based oligomer (and water), which polycondenses to form PET polymer. When PTA is reacted with ethylene glycol, a short chain PTA-based oligomer is formed which is characterised by a Dp (degree of polymerisation or number of repeat units) and a CEG (or carboxyl acid end group concentration). The degree of polymerisation (Dp) is calculated from the number average molecular weight Mn by the following formula: Dp = (Mn -62)/192, in which Mn is calculated by rearranging the following correlation for IV (intrinsic viscosity): IV = 1.7e-4 (Mn)^{0.83} . The intrinsic viscosity (IV) of the polyester can be measured by a melt viscosity technique equivalent to ASTM D4603-96. Typically, for a PTA-based oligomer formed by reacting PTA with ethylene glycol, the degree of polymerisation is usually between 3 and 7 and the CEG is usually between 500 and 1200 (mols acid ends / te of material). The carboxyl end group (CEG)/hydroxyl end group (HEG) ratio is determined from the CEG measurement and the rearrangement of following calculation of Mn: Mn = 2e6 / (CEG + HEG).

As used herein, “PET manufacturing process” refers to both manufacturing processes and facilities that have been designed and built from scratch to synthesize recycled PET (rPET), namely PET from substrates that include those derived from any post-consumer PET-containing waste material in addition to virgin substrates (i.e. vBHET or PTA-based oligomer), and also manufacturing processes and facilities that were built to synthesise vPET but which have been modified or retrofitted to allow the production of rPET. Changes that are required to a vPET facility in order to produce rPET are typically not major structurally but instead require a number of process changes. Such PET facilities may be integrated with a PTA manufacturing process or may be entirely independent.

As used herein, “vPET” refers to virgin PET, which is PET synthesised through a process requiring esterification of purified terephthalic acid with ethylene glycol. The purified terephthalic acid (PTA) is reacted with ethylene glycol to produce a PTA-based oligomer (and water), which polycondenses to form PET polymer. Alternatively, vPET may be formed through the reaction of dimethylterephthalate (DMT) (a diester formed from terephthalic acid and methanol) with ethylene glycol. A BHET monomer is formed through the reaction of dimethylterephthalate (DMT) (a diester formed from terephthalic acid and methanol) with ethylene glycol, and then the BHET monomer polymerises with itself to form longer chains of PET.

As used herein, “rPET” refers to recycled PET, which is PET manufactured entirely or at least partially from BHET oligomers that have been derived from post-consumer PET-containing waste material. The rPET may be synthesised from BHET oligomers (rBHET) that are 100% derived from post-consumer PET-containing waste material. Alternatively, the rPET may be synthesised from a combination of BHET oligomers that are derived from post-consumer PET-containing waste material (rBHET) and also from BHET oligomers (vBHET) used to make vPET. In one non-limiting embodiment, the rPET comprises at least 5% rBHET derived from post-consumer PET-containing waste material. In another non-limiting embodiment, the rPET comprises at least 50% rBHET derived from post-consumer PET-containing waste material. In yet another non-limiting embodiment, the rPET comprises at least 80% rBHET derived from post-consumer PET-containing waste material.

As used herein, “post-consumer PET-containing waste material” refers to any waste stream that contains at least 10% of PET waste. The post-consumer PET-containing waste material may therefore comprise 10% to 100% PET. The post-consumer PET-containing waste material may be municipal waste which itself includes at least 10% PET waste, such as PET plastic bottles or PET food packaging or any consumer recycled PET-containing waste material such as waste polyester fibre. Waste polyester fibre sources include items such as clothing items (shirts, trousers, dresses, coats etc.), bed linen, duvet linings or towels. The post-consumer PET-containing waste material may further comprise post-consumer recycled (PCR) flake, which is waste PET plastic bottles which have been mechanically broken into small pieces in order to be used in a recycling process.

The term “BHET” refers to the bis-hydroxylethyleneterephthalate monomer (C₁₂H₁₄O₆), including all structural isomers, which is characterised as having no carboxyl end groups, namely a carboxyl acid end group concentration (CEG) of zero. The chemical structure of the para-isomer of the BHET monomer is:

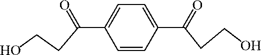 [SMILES: O=C(CCO)c1ccc(C(=O)CCO)cc1]

BHET reacts with itself to make longer chains in a polycondensation reaction, thereby forming polyethylene terephthalate and liberating ethylene glycol in the process. BHET, namely the BHET monomer, is typically formed through the reaction of dimethylterephthalate (DMT) with ethylene glycol, but it is also a minor component of the oligomer made from PTA plus ethylene glycol, i.e. part of the oligomeric molecular weight distribution.

The term “vBHET” refers to virgin BHET, which is the monomer formed through reaction of dimethylterephthalate (DMT) with ethylene glycol.

The term “rBHET” refers to recycled BHET, which is the oligomer produced by glycolyzing PET. Post-consumer PET-containing waste material, such as PET plastic bottles, is mechanically broken down to produce post-consumer recycled (PCR) flake. This PCR flake is then glycolysed to convert it to rBHET.

The term “vDMT” or “v-dimethyl terephthalate” refers to virgin dimethylterephthalate, which is a diester formed from esterification of purified terephthalic acid with methanol.

The term “rDMT” or “r-dimethyl terephthalate” refers to recycled DMT, which is dimethylterephthalate that originates from PCR-sourced PET (i.e. results from glycolysis of PCR-sourced PET to form rBHET, and then subsequent methanolysis of rBHET back to rDMT).

The term “L* color” refers to nomenclature that is well-established and defined by the International Commission on Illumination (CIE) in 1976 as the CIELAB color (also known as CIE L*a*b* or “Lab” color space). These parameters express color as three values: L* color for the lightness from black (0) to white (100), a* color from green (-) to red (+), and b* color from blue (-) to yellow (+). The CIELAB color space values are plotted in a cube form. The L* color axis runs from top to bottom. The maximum L* color value is 100, which represents a perfect reflecting diffuser. The minimum for L* color is 0, which represents black.

As used herein, “improvement in L*,” or variations thereof, refers to an increase in the L* value. An improvement may be an increase in L* of at least 0.1 L* unit, at least 0.5 L* units, at least 1 L* unit, at least 2 L* units, at least 3 L* units, at least 4 L* units, or at least 5 L* units. Preferably, an improvement in L* constitutes an increase in L* by 1 to 5 L* units. More preferably, an improvement in L* constitutes an increase in L* by 3 to 5 L* units. Measurement of L* can be performed using techniques known in the art. By nonlimiting example, L* may be determined using a color-view spectrophotometer. Samples for analysis may be presented as either amorphous base polymers or SSP chips.

As used herein, “free glycol” or “free ethylene glycol” or “free EG” refers to unreacted molecular ethylene glycol. Free glycol is, accordingly, not incorporated into any oligomer via covalent bond(s) and can be removed from a suspension or mixture by, for example, evaporation.

The quality of rPET is typically lower than vPET for a number of reasons including packaging design, quality of recovered bottle bales from recovery facilities, and reprocessing methods. Further, the discoloration and color variability of rPET is considered to be the primary quality issue affecting the adoption of rPET into packaging. This is related to many of the contaminants in rPET such as colored plastics, metals, non-plastic materials, labels, plastic films, and even dirt. The color of rPET color may vary from dark blue/grey to dark brown to yellow/brown.

For a vPET resin amorphous chip, which is the product of a melt phase process, the color parameters would typically be L* color of about 65, b* color of about -0.5 and a* color of about +0.5. However, a typical rPET resin made from a post-consumer PET-containing waste material or from vDMT or rDMT typically has an L* color of about 62. This lower L* would be representative of a darker color as compared to the L* of vPET.

The natural L* color of vPET is believed to be associated with the reduction of the antimony in the polycondensation catalyst Sb₂O₃ at temperatures above 200° C. (Aharoni, S.M. (1998), The cause of the grey discoloration of PET prepared by the use of antimony-catalysts. Polym Eng Sci, 38: 1039-1047. doi:10.1002/pen.10272).

It has now been found that both lowering free ethylene glycol and keeping the temperature below 220° C. at the point of catalyst addition in the PET manufacturing process is most beneficial to improving L* color of the polymer. Therefore, in one embodiment, the antimony-containing catalyst (Sb-containing) is added to the process at a temperature from 150° C. to 220° C.

In a PET manufacturing process using PTA-based oligomer to make vPET, it is not possible to keep the temperature below 220° C. at the point of catalyst addition because the PTA-based oligomer melting point is typically about 250° C. Therefore, keeping the temperature below 220° C. in order to improve L* color would be impossible for a vPET manufacturing process using conventional PTA-based oligomer.

In contrast, for rBHET, or for the vBHET monomer produced in a vDMT process and also the substrate produced in a rDMT process, the opposite is true. The melting point of these substrates is low (often <150° C.). Therefore, since the antimony reduction effectively stops below 220° C., addition of antimony-containing catalyst at low temperature is beneficial for improving L* color in PET manufacturing processes using rBHET and also vBHET produced in a vDMT process and in a rDMT process. In addition, the CEG content is low (often <100) and the free EG content (in some cases) is high (>10%). Therefore, lowering free ethylene glycol before addition of the antimony-containing catalyst is not only beneficial for improving L* in PET manufacturing processes using rBHET but also in processes using the substrates produced in vDMT and rDMT processes.

The disclosure therefore provides a method for improving L* color of polyethylene terephthalate polymer, wherein the polymer is produced by polycondensation of BHET in the presence of an antimony-containing catalyst and the method comprises the following steps: i) the antimony-containing catalyst is added at a temperature in a range from the melting point of the BHET to an upper temperature of 220° C.; and ii) the BHET in a molten state is exposed to glycol removal before addition of the antimony-containing catalyst.

In an embodiment, the antimony-containing catalyst is added in a temperature range from 150° C. to 200° C. In a further embodiment, the antimony-containing catalyst is added in a temperature range from 170° C. to 190° C. In a yet further embodiment, the antimony-containing catalyst is added in a temperature range from 185° C. to 195° C.

In an embodiment, the BHET in a molten state after the esterification stage is exposed to glycol removal in a temperature range of 150° C. to 200° C. In a further embodiment, this temperature range is between 170° C. and 190° C. In a yet further embodiment, the temperature range is between 185° C. and 195° C.

In an embodiment, the BHET in a molten state after the esterification stage is exposed to glycol removal at a pressure range of 100 mmHg to 760 mmHg. In a further embodiment, this pressure range is from 120 mmHg to 170 mmHg.

In an embodiment, BHET is derived from either post-consumer PET-containing waste material or from a dimethyl terephthalate process. The post-consumer PET-containing waste material may be PCR flake. The dimethyl terephthalate (DMT) process may be v-DMT or r-DMT.

In an embodiment, the antimony-containing catalyst may be antimony trioxide, antimony glycolate, or antimony triacetate.

In an embodiment, the L* color is improved in the range of 3 to 5 L* units.

In an alternative aspect, the process as disclosed herein provides a method for improving L* color of polyethylene terephthalate polymer, wherein BHET is polycondensed to produce said polyethylene terephthalate polymer in a polyethylene terephthalate manufacturing process. The alternative process employs a non-antimony-containing catalyst. In an embodiment, the catalyst comprises any one of titanium, zinc, aluminium, germanium or manganese. In an embodiment, the catalyst is a titanium alkoxide. In an alternative embodiment, the catalyst is titanium isopropoxide or titanium n-butoxide. In a further alternative embodiment, the catalyst contains any one of zinc acetate, manganese acetate, an alkyltin compound or an aluminium alkoxide.

In a further aspect, the disclosure provides a polyethylene terephthalate polymer produced by the process as described herein. Therefore, the disclosure provides a polyethylene terephthalate polymer, which is made by a process in which bis-hydroxylethyleneterephthalate is polycondensed to produce said polyethylene terephthalate polymer in a polyethylene terephthalate manufacturing process. The process requires an antimony-containing catalyst. The process comprises either or both of the following steps: i) the antimony-containing catalyst is added at a temperature in a range having a lower temperature delimited by the melting point of said BHET and an upper temperature of 220° C.; and/or ii) the BHET in a molten state is exposed to glycol removal before addition of the antimony-containing catalyst. The disclosure also provides a polyethylene terephthalate polymer, which is made by a process in which BHET is polycondensed to produce the polyethylene terephthalate polymer in a polyethylene terephthalate manufacturing process using a non-antimony-containing catalyst. In an embodiment, this catalyst may be any one of titanium, zinc, aluminium, germanium or manganese.

In yet a further aspect, the disclosure provides a shaped product produced by the polyethylene terephthalate polymer as described herein. Therefore, the disclosure provides a shaped product produced by the polyethylene terephthalate polymer, which is made by a process in which bis-hydroxylethyleneterephthalate is polycondensed to produce said polyethylene terephthalate polymer in a polyethylene terephthalate manufacturing process. The process requires an antimony-containing catalyst. The process comprises either or both of the following steps: i) the antimony-containing catalyst is added at a temperature in a range with a lower temperature delimited by the melting point of said BHET and an upper temperature of 220° C.; and/or ii) the BHET in a molten state is exposed to glycol removal before addition of said antimony-containing catalyst. The disclosure also provides a shaped product produced by the polyethylene terephthalate polymer, which is made by a process in which BHET is polycondensed to produce the polyethylene terephthalate polymer in a polyethylene terephthalate manufacturing process using a non-antimony-containing catalyst. In an embodiment, this catalyst may be any one of titanium, zinc, aluminium, germanium or manganese.

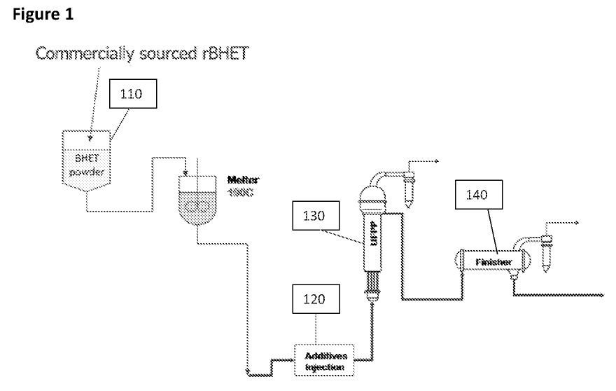

Referring to FIG. 1, in a process 100 for producing PET of improved L* color in accordance with one embodiment of the present disclosure, a PET substrate, such as rBHET, is fed from a hopper 110 into a reaction zone. The rBHET is melted at a temperature, e.g., 190° C. After being heated, additives and catalyst are added to the rBHET at additives zone 120. The mixture with the additives and catalyst is then transferred to a pre-polymeriser vessel (UFPP) 130, and then to a finisher vessel 140 to increase a degree of polymerisation of the polymeric product.

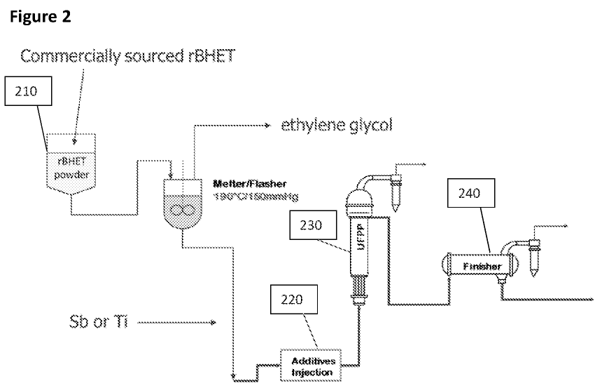

Referring to FIG. 2, in a process 200 for producing PET of improved L* color in accordance with an alternative embodiment of the present disclosure, a PET substrate, such as rBHET, is fed from a hopper 210 into a reaction zone. The mixture is heated in a flash vessel at a temperature, e.g., 190° C., and at a pressure, e.g., 150 mmHg, so that ethylene glycol is vaporized to reduce the amount of ethylene glycol. After being treated, additives and catalyst are added to the mixture at additives zone 220. This mixture with the additives and catalyst is then transferred to a pre-polymeriser vessel (UFPP) 230, and then to a finisher vessel 240 to increase a degree of polymerisation of the polymeric product.

The polymers and processes of the disclosure will now be more particularly described with reference to the following non-limiting Examples.

### EXAMPLES

The methods of the disclosure have been demonstrated on a 20 L (litre) semi-works scale batch reactor using the following experimental protocol.

Typically, either 8 kg of PTA-based oligomer or 10.58 kg of BHET were charged to the reactor under ambient conditions along with sufficient antimony trioxide catalyst to achieve 280 ppm antimony (Sb) (as element), cobalt acetate tetrahydrate to achieve 40 ppm Co (as element), and triethyl phosphate to achieve 20 ppm P (as element). As per the detailed examples below, other additives were added as described. The reactor was then isolated under a nitrogen blanket and heat applied. The reactor temperature set-point was then set to 260° C., and as the content’s temperature increased, the reactor pressure rose naturally in accordance with the volatile’s (water and ethylene glycol predominantly) vapour pressure. During this time and throughout this initial period the contents were agitated at 50 – 1200 rpm. Once 260° C. had been established, the reactor was held for the predetermined time, typically 30 – 60mins, before the pressure was released to atmospheric pressure and an oligomeric liquid sample taken. The vapours released during the pressure let down were condensed and collected in a receiving vessel. Once the oligomeric sample had been collected, vacuum was applied to the reactor stepwise from 1000mbara to full vacuum, typically less than 2mbara, in 250mbara steps with 15 minutes per step. At the same time the reactor temperature set-point was raised to 290° C. The reactor temperature set-point was typically achieved by the end of the vacuum let down; typically, after 60 minutes. The following period is referred to as the polycondensation time when the contents are held at 290° C., under full vacuum and agitated at 100 rpm. These conditions were maintained until the agitator torque reached a predetermined value of 15 Nm, associated with an intrinsic viscosity (iV) of 0.54 dl/g at which point the vacuum was released and the agitator stopped to degas the resulting polymer. Throughout the volatiles were condensed and collected as before. When degassing was complete, typically after 10 minutes, the molten polymer was discharged by 2barg overpressure and pelletised via a cooling trough.

The resulting polymer was then subjected to various standard PET analytical procedures including iV, carboxyl end group analysis (COOH), diethylene glycol analysis (DEG), CIE color analysis and X-ray fluorescence (XRF) analysis for metals content.

### Comparative Example 1

| Parameter | Value | Units |
|---|---|---|
| BHET | 8.0 | kg |
| H2O | 0.0 | kg |
| PTA | 0.0 | kg |
| CoAc.4H2O | 1.36 | g |
| TEP | 0.94 | g |
| Temp | 250 | °C |
| Pressure | 1.9 | barg |
| time | 40 | mins |
| Oligomer COOH | 40.7 | microeq/g |
| Temp | 290 | °C |
| Pressure | 1.5 | mbara |
| time | 75 | mins |
| iV | 0.549 | dl/g |
| COOH | 30.7 | microeq/g |
| Sb | 361 | ppm |
| P | 15.7 | ppm |
| Co | 49.2 | ppm |
| L* color | 45.61 | CIE |
| b* color | 11.5 | CIE |

In this case, comparative example 1, 8.0 kg of rPET sourced BHET was polymerised at 290° C. As can be seen in the table the polymer made had a COOH value of 30.7 microequivalents/g, an iV of 0.549dl/g, an L* color of 45.61 and a b* color of 11.5. The oligomer COOH number quoted in the table is for the starting material. In this example, the polymerisation time was 75 minutes.

### Comparative Example 2

| Parameter | Value | Units |
|---|---|---|
| PTA oligomer | 8.0 | kg |
| H2O | 0.0 | kg |
| PTA | 0.0 | kg |
| CoAc.4H2O | 1.36 | g |
| TEP | 0.94 | g |
| Temp | 250 | °C |
| Pressure | 2.8 | barg |
| time | 50 | mins |
| Oligomer COOH | 924 | microeq/g |
| Temp | 290 | °C |
| Pressure | 1.8 | mbara |
| time | 95 | mins |
| iV | 0.541 | dl/g |
| COOH | 26.4 | microeq/g |
| Sb | 274 | ppm |
| P | 55 | ppm |
| Co | 39 | ppm |
| L* color | 63.99 | CIE |
| b* color | 9.89 | CIE |

In comparative example 2, 8.0 kg of commercial-scale PTA-based oligomer was polymerised at 290° C. As can be seen in the table the polymer made had a COOH value of 26.4 microequivalents/g, an iV of 0.541dl/g, an L* color of 63.99 and a b* color of 9.89. The oligomer COOH number quoted in the table above is for the starting material. In this example, the polymerisation time was 95 minutes.

### Comparative Example 3

| Parameter | Value | Units |
|---|---|---|
| PTA | 6.92 | kg |
| EG | 3.62 | kg |
| H2O | 0.0 | kg |
| CoAc.4H2O | 1.36 | g |
| TEP | 0.94 | g |
| Temp | 250 | °C |
| Pressure | 1.9 | barg |
| time | 40 | mins |
| Oligomer COOH | | microeq/g |
| Temp | 290 | °C |
| Pressure | 1.5 | mbara |
| time | 75 | mins |
| iV | 0.535 | dl/g |
| COOH | 30.9 | microeq/g |
| Sb | 211 | ppm |
| P | 11 | ppm |
| Co | 27.5 | ppm |
| L* color | 59.45 | CIE |
| b* color | 12.56 | CIE |

In comparative example 3, 6.92 kg of vPTA was reacted with 3.62 kg of ethylene glycol at 246° C. for nine hours. The pressure of the vessel was allowed to rise as esterification took place and was vented periodically from 9barg down to 4barg to allow release of water. When no further pressure rise was observed the batch was allowed to cool and the additives charged as in the previous examples. The resulting oligomer was then polymerised at 290° C. As can be seen in the table the polymer made had a COOH value of 30.9 microequivalents/g, an iV of 0.535dl/g, an L* color of 59.45 and a b* color of 12.56. No oligomer COOH number is available for this example. In this example, the polymerisation time was 75 minutes.

### Example 4

In this example the rBHET material was subjected to a pre-treatment whereby it was heated to about 190° C. at atmospheric pressure followed by a vessel pressure reduction to 100mbara in 200mbara steps over 40 minutes. This pressure reduction resulted in the removal of unreacted free glycol by evaporation. The resulting oligomer post-flash was then held at this reduced temperature for 50 minutes before polymerisation following the normal protocol.

| Parameter | Value | Units |
|---|---|---|
| BHET | 10.58 | kg |
| CoAc.4H2O | 40 | ppm |
| TEP | 20 | ppm |
| Oligomer Flash | | |
| Temp | 187 | °C |
| Press | 1000-100 | mbara |
| Time | 50 | mins |
| Oligomer hold | | |
| Temp | 193 | °C |
| Pressure | 2.9 | barg |
| time | 60 | mins |
| Polymerisation | | |
| Temp | 284 | °C |
| Pressure | 1.6 | mbara |
| time | 70 | mins |
| iV | 0.529 | dl/g |
| COOH | 28.2 | microeq/g |
| Sb | 370 | ppm |
| P | 34.7 | ppm |
| Co | 38.7 | ppm |
| L* color | 48.3 | CIE |
| b* color | 14.19 | CIE |

As can be seen in the above table, the polymer had a COOH value of 28.2 microequivalents/g, an iV of 0.529 dl/g, an L* color of 48.3 and a b* color of 14.19. The polymer L* color is significantly enhanced over Comparative Example 1 made with the same starting material. In this example, the polymerisation time was 70 minutes.

In this and subsequent cases the Co and P were added as a premix solution in ethylene glycol (0.353 wt% Co, 0.204 wt% P).

### Example 5

In this example the rBHET material is subjected the same pre-treatment as Example 4 whereby it was heated to about 190° C. at atmospheric pressure and then the vessel pressure reduced to 100mbara in 200mbara steps over 40 minutes. This pressure reduction results in the removal of unreacted free glycol by evaporation. This time however the post-flash oligomer is held at the more typical 260° C. for 60 minutes.

| Parameter | Value | Units |
|---|---|---|
| BHET | 10.58 | kg |
| CoAc.4H2O | 40 | ppm |
| TEP | 20 | ppm |
| Oligomer Flash | | |
| Temp | 187 | C |
| Press | 1000-100 | mbara |
| Time | 50 | mins |
| Oligomer hold | | |
| Temp | 260 | °C |
| Pressure | 1.9 | barg |
| time | 60 | mins |
| Polymerisation | | |
| Temp | 290 | °C |
| Pressure | 1.6 | mbara |
| time | 70 | mins |
| iV | 0.529 | dl/g |
| COOH | 28.2 | microeq/g |
| Sb | 370 | ppm |
| P | 34.7 | ppm |
| Co | 38.7 | ppm |
| L* color | 46.8 | CIE |
| b* color | 12.2 | CIE |

As can be seen in the above table, the polymer has a COOH value of 28.2 microequivalents/g, an iV of 0.529dl/g, an L* color of 46.8 and a b* color of 12.2. The polymer L* color is enhanced over comparative example 1 but a little lower than example 4. In this example, the polymerisation time is 70 minutes.

### Example 6

In this example the rBHET material is not subjected to the pre-treatment of Example 4 but is held at the reduced 190° C. oligomer hold temperature for 60 minutes.

| Parameter | Value | Units |
|---|---|---|
| BHET | 10.58 | kg |
| CoAc.4H2O | 40 | ppm |
| TEP | 20 | ppm |
| Oligomer hold | | |
| Temp | 190 | °C |
| Pressure | 1.9 | Barg |
| time | 60 | mins |
| Polymerisation | | |
| Temp | 290 | °C |
| Pressure | 1.6 | mbara |
| time | 70 | mins |
| iV | 0.529 | dl/g |
| COOH | 28.2 | microeq/g |
| Sb | 370 | ppm |
| P | 34.7 | ppm |
| Co | 38.7 | ppm |
| L* color | 47.3 | CIE |
| b* color | 12.2 | CIE |

As can be seen in the table the polymer has a COOH value of 28.2 microequivalents/g, an iV of 0.529dl/g, an L* color of 47.3 and a b color of 12.2. The polymer L* color is enhanced over comparative example 1 but a little lower than example 4. The polymerisation time is 70 minutes.

### Comparative Example 7

In the following example, an alternative, more highly refined rBHET source is introduced. Interestingly this material has a much lower unreacted free glycol content and is antimony-free. It also has a higher natural L* color value.

| Material | wt% Free EG | Sb/ppm | COOH | L* | b* |
|---|---|---|---|---|---|
| Comparative example 1 | 12.0 | 71 | 14.6 | 96.6 | 2.72 |
| Comparative example 7 | <1.0 | 0 | 40.7 | 88.4 | 4.98 |

The batch conditions were as follows:

| Parameter | value | units |
|---|---|---|
| BHET | 10.58 | kg |
| CoAc.4H2O | 40 | ppm |
| TEP | 20 | ppm |
| Oligomer hold | | |
| Temp | 250 | °C |
| Pressure | 2.1 | barg |
| time | 60 | mins |
| Temp | 290 | °C |
| Pressure | 1.2 | mbara |
| time | 72 | mins |
| iV | 0.527 | dl/g |
| COOH | 22.6 | microeq/g |
| Sb | 204 | ppm |
| P | 10.2 | ppm |
| Co | 35.3 | ppm |
| L* color | 52.0 | CIE |
| b* color | 8.11 | CIE |

As can be seen in the table the polymer made had a COOH value of 22.6 microequivalents/g, an iV of 0.527dl/g, an L* color of 52.0 and a b* color of 8.11. The polymer L* color is enhanced over comparative example 1 but still lower than comparative examples 2 and 3. The polymerisation time was 72 minutes.

### Example 8

In the following example, the antimony trioxide catalyst is replaced with 10 ppm (Ti-basis) of titanium tetra n-butoxide. The alternative rBHET material of comparative example 7 was used as feed and the batch conditions were as detailed below.

| Parameter | Value | Units |
|---|---|---|
| BHET | 10.58 | kg |
| CoAc.4H2O | 40 | ppm |
| TEP | 20 | ppm |
| Ti (n-BuO)4 | 10 | ppm |
| Temp | 194 | °C |
| Pressure | 0.6 | barg |
| time | 60 | mins |
| Temp | 290 | °C |
| Pressure | 1.4 | mbara |
| time | 45 | mins |
| iV | 0.517 | dl/g |
| COOH | 25.7 | microeq/g |
| Sb | 0 | ppm |
| P | 10.5 | ppm |
| Co | 37.8 | ppm |
| L* color | 58.17 | CIE |
| b* color | 14.7 | CIE |

As can be seen in the table the polymer made had a COOH value of 25.7 microequivalents/g, an iV of 0.517dl/g, an L* color of 58.17 and a b* color of 14.7. The polymer L* color is enhanced over comparative example 7 but b* color has been compromised. The polymerisation time was a much-reduced 45 minutes.

1. A method for improving L* color of polyethylene terephthalate (PET) polymer, the method comprising polycondensing bis-hydroxylethyleneterephthalate (BHET) to produce the polyethylene terephthalate polymer in a polyethylene terephthalate manufacturing process, and wherein the said process requires an antimony-containing catalyst, the method comprising the steps of:
i) adding the antimony-containing catalyst at a temperature in a range of a melting point of the BHET to an upper temperature of 220° C.; and
ii) exposing the BHET in a molten state to glycol removal to below 10% free glycol and preferably below 5% free glycol prior to the addition of the antimony-containing catalyst.

2. The method according to claim 1, wherein the said antimony-containing catalyst is added at a temperature between 150° C. to 200° C., preferably from 170° C. to 190° C., more preferably between 185° C. to 195° C.

3. The method according to claim 1, wherein the BHET in the molten state is exposed to glycol removal at a temperature range of 150° C. to 200° C., preferably from 170° C. to 190° C., more preferably between 185° C. to 195° C.

4. The method according to claim 1, wherein the exposure to glycol removal occurs at a pressure range of 100 mmHg to 760 mmHg, preferably 120 mmHg to 170 mmHg.

5. The method according to claim 1, wherein the BHET is derived from either post-consumer PET-containing waste material or from a dimethyl terephthalate process.

6. The method according to claim 5, wherein the dimethyl terephthalate is v-dimethyl terephthalate or r- dimethyl terephthalate.

7. The method according to claim 6, wherein the post-consumer PET-containing waste material is a post-consumer recycled (PCR) flake.

8. The method according to claim 1, wherein the antimony-containing catalyst is antimony trioxide, antimony glycolate or antimony triacetate.

9. A method for improving L* color of polyethylene terephthalate polymer by adding a non-antimony-containing catalyst, wherein bis-hydroxylethyleneterephthalate is polycondensed to produce the polyethylene terephthalate polymer in a polyethylene terephthalate manufacturing process.

10. The method according to claim 9, wherein the non-antimony-containing catalyst includes any one of titanium, zinc, aluminium, germanium or manganese.

11. The method according to claim 10, wherein the non-antimony-containing catalyst is a titanium alkoxide, titanium isopropoxide or titanium n-butoxide.

12. The method according to claim 9, wherein the non-antimony-containing catalyst contains any one of zinc acetate, manganese acetate, an alkyltin compound or an aluminium alkoxide.

13. A polyethylene terephthalate polymer produced by the process as claimed in claim 1.

14. A shaped product produced by the polyethylene terephthalate polymer claimed in claim 1.

15. A polyethylene terephthalate polymer produced by the process as claimed in claim 9.

16. A shaped product produced by the polyethylene terephthalate polymer claimed in claim 9.
